(19) United States
(12) Patent Application Publication
(10) Pub. No.: US 2019/0137426 A1
(43) Pub. Date: May 9, 2019

(54) Gas Sensor

(71) Applicant: Figaro Engineering Inc., Minoo-shi (JP)

(72) Inventor: Kenichi Yoshioka, Minoo-shi (JP)

(21) Appl. No.: 16/308,546

(22) PCT Filed: May 11, 2017
(86) PCT No.: PCT/JP2017/017820

§ 371 Date: Dec. 10, 2018

(30) Foreign Application Priority Data
Jun. 23, 2016 (JP) 2016-124212

(51) Int. Cl. G01N 27/12

(52) U.S. Cl. CPC G01N 27/12

(57) ABSTRACT

Through a silica-based adsorbent filter containing sulfo group, surrounding atmosphere is introduced to a gas sensing element. The diameter D in mm of an opening in a housing at a position covering the filter and the length L in mm of the filter along the direction from the opening toward the gas sensing element are related as 0.1≤D≤1.5, 2≤L≤12, L/D^{2/3}≤10, 5≤L/D. The detection delay for a gas to be detected is kept within an allowable range, the size of the sensor is not made too large, and the long-term stability of the gas sensor is improved.

### TECHNICAL FIELD

The present invention relates to filters in gas sensors

### BACKGROUND ART

Gas sensors have the problem of being poisoned by organo-siloxanes and similar gases. Therefore, filters such as active carbon (Patent Document 1: JP4104,100B), mesoporous silica (Patent Document 2: JP2013-242,269A), colloidal silica (Patent Document 3: JP5841,810B), and so on have been proposed. Further, it is known that sulfo group in the filter is effective for the removal of siloxanes (Patent Document 3). More, it is known to restrict the introduction amount of surrounding air into the filter is effective for using the filter.

### LIST OF PRIOR TECHNICAL DOCUMENTS

### Patent Documents

Patent Document 1: JP4104,100B

Patent Document 2: JP2013-242,269A

Patent Document 3: JP5841,810B

### SUMMARY OF THE INVENTION

### Problems to be Solved by the Invention

For improving the long-term stability of gas sensors, it is necessary to increase the amount of adsorbent in the filter. However, the increase in the amount of adsorbent results in a delay in response and makes the size of the gas sensor larger.

The object of the invention is to improve the long-term stability of gas sensors while keeping the delay in response to the gas to be detected within an allowable range and keeping the size of the gas sensors within a practical range.

### Means for Solving the Problems

A gas sensor according to the invention introduces the surrounding atmosphere through a filter to a gas sensing element,

the filter comprises a silica-based adsorbent containing sulfo group,

the gas sensor is provided with a housing accommodating the filter and the gas sensing element,

the housing is provided with an opening through which the surrounding atmosphere is introduced into the filter,

the diameter of the opening is denoted by D in mm, the length of the filter in the direction from the opening toward the gas sensing element is denoted by L in mm, and

0.1≤D≤1.5, 2≤L≤12, L/D^{2/3}≤10, and 5≤L/D.

The silica-based adsorbent containing sulfo group and active carbon conventionally used in gas sensors are different in the following points:

the silica-based adsorbent containing sulfo group has not a high siloxane adsorption capacity; and

siloxanes adsorbed on the silica-based adsorbent containing sulfo group does not desorb but siloxanes adsorbed on active carbon desorb.

When using the silica-based adsorbent containing sulfo group as the filter and when extending the length of the filter (the thickness of the filter from an opening to surrounding atmosphere toward the gas sensing element), utilizing the short detection delay, the period before breakthrough of siloxanes is made longer. The extended length of the filter, however, makes the size of the gas sensor too large. On the contrary, when making the diameter of the opening for introducing the surrounding atmosphere to the filter smaller, then the period before breakthrough is extended without extending the length of the filter.

The inventor has investigated the influence of the length L of the filter and the diameter D of the opening on the detection delay and on the period before breakthrough of siloxanes. Then it is found that the detection delay is determined according to L/D^{2/3} and the period before breakthrough is according to L/D. The dependency on D is different between the detection delay and the period before breakthrough, and when making D smaller, then the period before breakthrough is made longer while keeping the detection delay short. In consideration with controlling the diameter D of the opening uniform and with keeping the size of the gas sensor within a practical range, 0.1≤D≤1.5, 2≤L≤12, L/D^{2/3}≤10, and 5≤L/D in mm 5≤L/D is the condition for extending the period before breakthrough, and L/D^{2/3}≤10 is the condition for keeping the detection delay within an allowable range. Further, for keeping the length of the filter within a practical range, L is determined such that 2≤L≤12, for satisfying the condition of 5≤L/D, D is made up to 1.5 mm, and for fabricating the uniform openings, D is made down to 0.1 mm.

Here, when 0.3 mm≤D≤1.2 mm, the openings with a uniform diameter are easily fabricated,

when 3 mm≤L≤10 mm, the gas sensor has a size suitable for easy implementation, and when 7≤L/D, the period before breakthrough is made longer. Further, when 0.3 mm≤D≤1.2 mm, 3 mm≤L≤10 mm, 7≤L/D, and L/D^{2/3}≤6.5, the detection delay is made further shorter.

The diameter of the filter is denoted by R in mm in a plane perpendicular to a direction from the opening of the filter toward the gas sensing element (the lengthwise direction of the filter). When making R larger, the influence on the detection delay is small and the period before breakthrough is extended. Therefore preferably, R is set 6 mm≤R≤16 mm.

For applying the invention to a non-circular opening, a virtual diameter D′ of the opening and the area S of the opening are related in such a way that S=π/4·D′² and D′=(4S/π)^{1/2}, and the virtual diameter D′ is used in place of the diameter D. Similarly, when the cross-section of the filter is not circular, a virtual diameter R′ of the filter and the area S′ of the filter are related in such a way that S′=π/4·R′² and R′=(4S′/π)^{1/2}, and the virtual diameter R′ is used in place of the diameter R.

The silica-based adsorbent is, for example, silica gel, mesoporous silica, high-silica zeolite and, since it has a large mean pore diameter, the detection delay is short, and the adsorbed siloxanes are polymerized by the sulfo group introduced. The mean pore diameter is, for example, down to 1 nm and up to 20 nm, specifically down to 2 nm and up to 20 nm, preferably down to 3 nm and up to 20 nm, and particularly preferably down to 4 nm and up to 20 nm.

A gas sensor according to the invention introduces the surrounding atmosphere through a filter to a gas sensing element,

the filter comprises a silica-based adsorbent containing sulfo group,

the gas sensor is provided with a housing accommodating the filter and the gas sensing element,

the housing is provided with an opening through which the surrounding atmosphere is introduced into the filter, and

the diameter of the opening is denoted by D in mm, the length of the filter in the direction from the opening toward the gas sensing element is denoted by L in mm, and the area of the opening is denoted by S in mm², and

0.1≤D≤1.5, 2≤L≤12, 5≤L/(4S/π)^{1/2}, L/(4S/π)^{1/3}≤10.

Preferably, 0.3≤D≤1.2, 3≤L≤10, 7≤L/(4S/π)^{1/2}, and L/(4S/π)^{1/3}≤6.5. The inventor has confirmed that, when the opening is not circular or when plural openings are present, the sum of the areas of the openings is important and that L/(4S/p)^{1/2} should be used in place of L/D. More, the inventor has confirmed that L/(4S/p)^{1/3} should be used in place of L/D^{2/3}. For example, when one opening is present and when the diameter of the opening is D, S is given by π/4·D², and inversely D=L/(4S/π)^{1/2} holds. Regarding the area S′ of the opening, 6≤(4S′/π)^{1/2}≤16 is preferable, when S′ denotes the area of the filter in mm² in a cross-section perpendicular to the direction from the opening toward the gas sensing element.

In the present specification, the filter comprising a silica-based adsorbent containing sulfo group means that the silica-based adsorbent is 60% or more by mass ratio in the adsorbent in the filter, preferably 70% or more. For example, active carbon loaded with a precious metal such as Pt may be contained at a concentration of 40% or less by mass ratio, preferably 30% or less, in the adsorbent. Since an adsorbent such as active carbon is a cause of detection delay, when a layer of active carbon or the like is provided within the filter, the thickness of this layer is included in the thickness of the filter.

### BRIEF DESCRIPTION OF DRAWINGS

FIG. 1 A sectional view of a gas sensor according to an embodiment

FIG. 2 A plan view of a chip in the gas sensor according to an embodiment

FIG. 3 A characteristic diagram of the relationship between L/D^{2/3} and delay in detection

FIG. 4 A characteristic diagram of the relationship between L/D and period before the breakthrough

FIG. 5 A diagram indicating the definition of filter size in a modification

FIG. 6 A sectional view of a gas sensor according to a second modification

FIG. 7 A front view of the gas sensor according to the second modification

FIG. 8 A sectional view of a gas sensor according to a third modification

FIG. 9 A plan view of the gas sensor according to the third modification

### EXAMPLES FOR CARRYING OUT THE INVENTION

The best embodiment for carrying out the invention will be described in the following.

### Embodiment

Structure of Gas Sensor

FIG. 1 indicates a gas sensor 2 according to an embodiment. A chip 4 (a gas sensing element) having a gas sensing membrane made of a metal oxide semiconductor is fixed to a base 6 and the chip 4 is connected to a substrate through leads 8. A filter comprising an adsorbent for siloxane gases is denoted by 10, accommodated in a cap 12, introduces the surrounding gas from an opening 14, and supplies the surrounding gas toward the chip 4 through an opening 17 in a ring 16. The filter may be shaped into a circular column or an adequate shape with a binder, and the openings 14, 17 may be covered by gas permeable sheets such as un-woven fabrics.

The openings 14, 17 are for example circular, and the cap 12 is for example in the shape of a circular tube. The diameter of the opening 14 is denoted by D, the length of the filter 10 along the direction connecting the openings 14-17 is denoted by L, and the diameter of the filter 10 on a plane perpendicular to the above direction is denoted by R. In the present specification, the length and the diameters of the openings are indicated in mm. The diameter of the opening 17 is made, for example, more than twice the diameter of the opening 14.

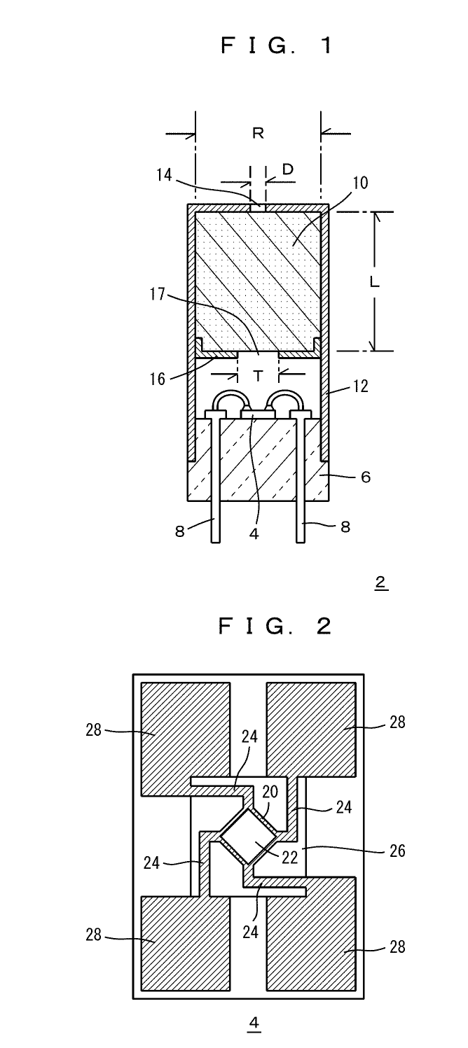

FIG. 2 indicates the chip 4; over a cavity 26 in a silicon substrate is an insulating film 20, and the gas sensing membrane 22 is formed on the insulating film 20. The electrodes and the heater, or the like, if any, are connected to pads 28 through beams 24. The gas sensing membrane 22 is a thick membrane of SnO₂ according to the embodiment; it may be a thick membrane of WO₃ or the like and may be a thin membrane. Further, the gas sensing membrane may comprise a contact combustion catalyst, for example, Pt or the like, loaded on an alumina carrier. The gas sensing element is not limited to the chip 4. For example, a gas sensor where the gas sensing membrane 22 is provided on a substrate such as alumina supported by unshown lead wires; an electrochemical gas sensor comprising a proton conductive membrane, a detection electrode on one face of the membrane directing the filter 10, and a counter electrode on the opposite face; and a contact combustion-type gas sensor may be usable. Particularly important are the gas sensor having the chip 4 for the detection of fuel gases such as methane and LPG and the electrochemical gas sensor for the detection of CO.

A gas sensor 2 where the gas sensing membrane 22 was a 30 μm thick SnO₂ membrane containing 1.5 mass % Pd was prepared. The material of the filter 10, the diameter D of the opening 14, the length L of the filter, and its diameter R were changed so that their influences on the delay time τ before detection and the periods before siloxane gases penetrated the filters were measured. The gas sensor 2 was a sensor for detecting methane or LPG, was operated with a period of 30 seconds and, during every period, the gas sensing membrane 22 was heated to 450° C. for 0.1 second.

Measurements

The gas sensors 2 were operated for 80 days in an atmosphere containing siloxanes M3, D4, and D5, each at a concentration of 50 ppm, and the resistivities of the gas sensing membrane in a methane 3000 ppm atmosphere were measured for measuring breakthrough periods till siloxane gases penetrating the filter. When the resistivity decreased to or under an initial resistivity in a methane 500 ppm atmosphere, the inventor deemed that a breakthrough of the filter 10 occurred, in other words, the siloxane gas penetrated the filter 10, and the periods till the breakthrough were measured. The test in the atmosphere containing siloxanes M3, D4, and D5, each 50 ppm, is an extremely accelerated one, and the breakthrough period of 9 days corresponds to the durability of one year in actual use.

Further, the heating period of the sensor 2 was shortened to 1 second, and the sensor 2 was made in contact with an atmosphere containing methane 12500 ppm. The lag time before the resistivity of the gas sensing membrane decreased to or under the resistivity corresponding to methane 3000 ppm was measured and was evaluated as the delay time τ in response. Practically, τ should be equal to or under 50 seconds and is preferably equal to or under 30 seconds.

Preparatory Experiment

As the filter material, five commercial species of granular active carbon (active carbons A-E: all without sulfo group) were tested. In addition to them, a silica gel introduced with sulfo group was tested. A raw silica gel having a BET specific surface area of 500 m²/g, a pore volume of 0.8 cm³/g, and a mean pore diameter of 6.4 nm was mixed with a para-toluene sulfonic acid aqua solution (5 mass % concentration) and then dried at a highest temperature of 140° C. so as to prepare the silica gel introduced with sulfo group. In the example, while the silica gel contained 5 mass % of para-toluene sulfonic acid; the para-toluene sulfonic acid content is arbitrary and it may be changed, for example, within a range of 1 mass % to 15 mass %. Instead of para-toluene sulfonic acid, other sulfonic acid compounds such as naphthalene sulfonic acid and bis-phenol sulfonic acid may be usable and the species of the organic compound for introducing sulfo group is arbitrary. Assuming the whole amount of the mixed para-toluene sulfonic acid was loaded in the silica gel, then, the concentration of sulfo group was 2.4 mass % when 5 mass % para-toluene sulfonic acid was contained. The concentration of sulfo group in the silica gel is, for example, not less than 0.4 mass % and not more than 7 mass %.

The caps where the diameter D of the opening was 4 mm and the diameter R of the filter was 8 mm were filled with one of the filter materials at an amount of 100 mg and the detection delay τ (in second) and the periods before the breakthrough of the filter (day) were measured. The results are shown in Table 1.

TABLE 1
Filter Materials, Periods before the BreakThrough,
and Detection Delay τ

| | Periods | | Upper Limit |
|---|---|---|---|
| | before | Detection | before |
| Material | BreakThrough (d) | Delay τ (s) | BreakThrough (d)* |
| Acitive Carbon A | 6 | 25 | 6 |
| Acitive Carbon B | 6 | 40 | 4 |
| Acitive Carbon C | 12 | 20 | 15 |
| Acitive Carbon D | 12 | 30 | 10 |
| Acitive Carbon E | 21 | 25 | 21 |
| Silica Gel | 14 | 5 | 70 |

*The periods before the breakthrough indicate the days till the alarm concentration of methane decreased to 500 ppm or less, and the upper limit before the breakthrough is an expected days before breakthrough when the filter amount is adjusted so that τ is set to 25 seconds.
*Into the silica gel, para-toluene sulfonic acid was added at a concentration of 5 mass %.

While the active carbon E showed the longest period before the breakthrough, the detection delay is nearly at the upper limit, and increasing the amount of active carbon E was, therefore, difficult. The silica gel introduced with sulfo group showed a moderate period before the breakthrough but showed the shortest delay τ in detection. Therefore, the inventor noticed the possibility to elongate the period before the breakthrough and to keep the detection delay τ within 30 seconds by increasing this filter material. Upper limits of the period before the breakthrough are shown in Table 1; they are the expected periods when adjusting the amounts of the filter materials so as to make the detection delay τ to the same as that of the active carbon E. The upper limit is calculated as the period before the breakthrough ÷τ×25 and the constant 25 was determined so that the active carbon E has an upper limit of 21 days. The silica gel introduced with sulfo group showed the longest upper limit before the breakthrough of 70 days.

The 100 mg silica gel filter had a length of 4.4 mm. In order to achieve the upper limit of 70 days, if the length is made five times, it becomes 22 mm. This length hinders the implementation of gas sensor 2 on a substrate. Therefore, the inventor considered to restrict the diameter D of the opening in order to restrict the size of the gas sensor within a practical range. The prerequisite for this was that the detection delay τ was within an allowable range (for example 30 seconds or less) and that the period before the breakthrough is long (for example, 30 days or more and 50 days or more, if possible).

From the filters after the siloxane durability test, the active carbon E and the silica gel in Table 1 were extracted, were heated till 200° C. and the desorbing materials were analyzed by GCMS. Peaks for the siloxanes were detected for the active carbon but they were not detected for the silica gel. This indicates that siloxanes polymerized in the silica gel with the interaction between the sulfo group.

Silica gels introduced with sulfo group where 5 mass % of para-toluene sulfonic acid was added and had mean pore diameters of 4.8 nm and 11 nm were subjected to a similar test to the one in Table 1, where the filter amounts were 100 mg. The periods before breakthrough were 12 days (mean pore diameter of 4.8 nm) and 10 days (mean pore diameter of 11 nm) and the detection delays were 10 seconds (mean pore diameter of 4.8 nm) and 6 seconds (mean pore diameter of 11 nm). On the contrary, the mean pore diameters of the active carbon A-E were from 1.8 to 2.5 nm. Based upon these facts, the inventor estimated that the small mean pore diameter of the active carbons caused the detection delay and that the large mean pore diameter of the silica gel made the polymerization of siloxanes in the pores by the sulfo group.

Experimental

While fixing the length L of the filter at 8 mm, the diameter R at 8 mm, the diameter D of the opening was changed from a conventional value of 4 mm to 0.1 mm (specimens 1-7), where the silica gel content was 0.18 g and it was the silica gel with sulfo group used in the preparatory experiment in Table 1. More, while fixing the diameter D of the opening of the filter at 1.0 mm, the diameter R at 8 mm, the length L of the filter was changed within a range of 12 mm to 4 mm (specimens 8-11). Further, specimens where the values of D and L were randomly changed (specimens 12-16) and specimens where the diameter R was changed (specimens 17-20) were prepared. In the preparation of the specimens, the filter material was filled and tapped in order to make the packing density uniform between the specimens. Then, the detection delay τ and the period before breakthrough were measured for these specimens.

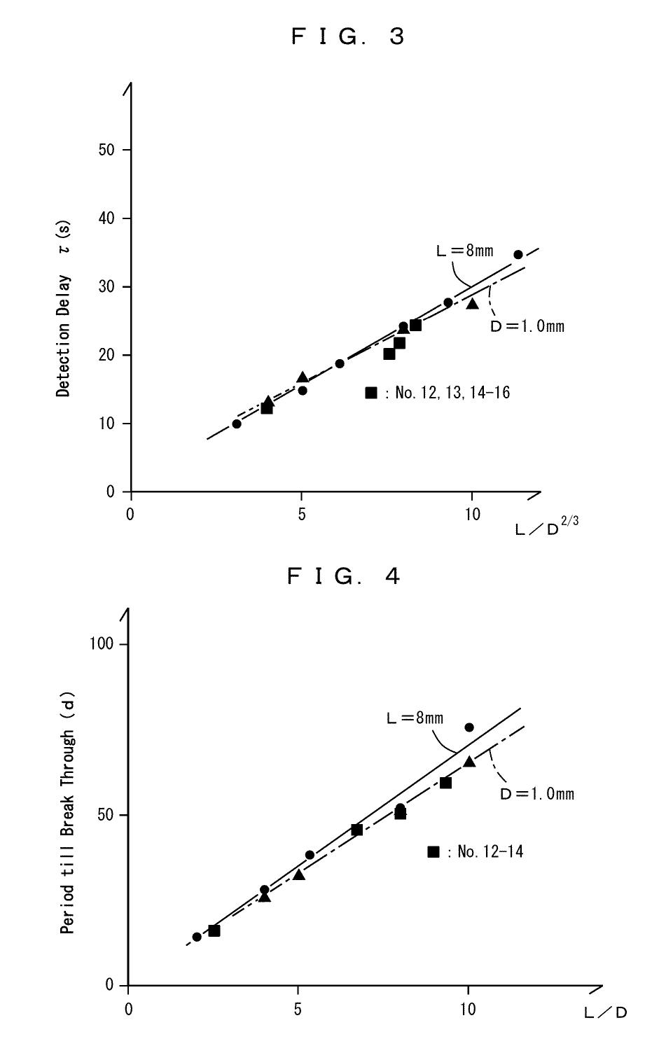

The results are shown in Table 2 and FIGS. 3 and 4. As indicated in FIG. 3, the detection delay τ was determined by L/D^{2/3}. Further, the data when L was fixed at 8 mm and the data when D was fixed at 1.0 mm are substantially the same and when the values of D and L were changed randomly the results were similar. As described above, the length L of the filter was proportional to the detection delay τ and the detection delay τ was inversely proportional to ⅔ th power of the diameter D of the opening. The reason why, not L/D² indicative of the ratio of the filter length and the opening area or the like, but L/D^{2/3} determines the delay τ is unknown. It is clear from FIG. 3 that the detection delay τ is shortened up to 30 seconds when L/D^{2/3} is made up to 10 and is shortened up to 20 seconds when L/D^{2/3} is made up to 6.5.

The period before breakthrough was determined by the ratio L/D of the length L and the diameter D of the opening. When L was fixed at 8 mm, when D was fixed at 1.0 mm, and when both L and D were randomly changed, the same value of L/D resulted in the similar periods before breakthrough. Furthermore, the detection delay τ and the period before breakthrough had a different dependency on the diameter D of the opening. Therefore, when L/D^{2/3} is made up to 10 and L/D down to 5, the detection delay Σ is made up to 30 seconds and the period before breakthrough is made down to 30 days (lifetime of 3 years or more in actual use). When L/D^{2/3} is made up to 10 and L/D down to 7, the detection delay τ is made up to 30 seconds and the period before breakthrough is made down to 50 days (lifetime of 5 years or more in actual use). And when L/D^{2/3} is made up to 6.5 and L/D down to 7, the detection delay τ is made up to 20 seconds and the period before breakthrough is made down to 50 days.

The diameter D of the opening has no intrinsic lower limit, but for making the fabrication easier and for preventing the variation of the diameter of the opening, D is made not smaller than 0.1 mm and not larger than 1.5 mm and is preferably not smaller than 0.3 mm and not larger than 1.2 mm

Table 2 also show results for various diameters R of the filter. When L and D are constant, the increase in R significantly increases the period before breakthrough but does not significantly increase the detection delay τ. Namely, a larger value of R is advantageous. Since a suitable range of gas sensor size is present for easy implementation, R is preferably not smaller than 6 mm and not larger than 16 mm

TABLE 2
The Influence of the Diameter D of the
Opening and the Length of the Filter

| | | | | | | | Period |
|---|---|---|---|---|---|---|---|
| | | | | | | | before |
| | D | L | R | | | delay | Break- |
| Specimen No. | (mm) | (mm) | (mm) | L/D | L/D^{2/3} | τ (s) | through(d) |
| 1 | 4 | 8 | 8 | 2 | 3.1 | 10 | 14 |
| 2 | 2 | 8 | 8 | 4 | 5 | 15 | 28 |
| 3 | 1.5 | 8 | 8 | 5.3 | 6.1 | 18 | 38 |
| 4 | 1.0 | 8 | 8 | 8 | 8 | 24 | 52 |
| 5 | 0.8 | 8 | 8 | 10 | 9.3 | 28 | 76 |
| 6 | 0.6 | 8 | 8 | 13 | 11.3 | 35 | >80 |
| 7 | 0.3 | 8 | 8 | 27 | 18 | 55 | >80 |
| 8 | 1.0 | 4 | 8 | 4 | 4 | 11 | 26 |
| 9 | 1.0 | 5 | 8 | 5 | 5 | 14 | 32 |
| 4 | 1.0 | 8 | 8 | 8 | 8 | 24 | 52 |
| 10 | 1.0 | 10 | 8 | 10 | 10 | 28 | 66 |
| 11 | 1.0 | 12 | 8 | 12 | 12 | 32 | >80 |
| 12 | 4 | 10 | 8 | 2.5 | 3.9 | 12 | 16 |
| 13 | 1.5 | 10 | 8 | 6.7 | 7.6 | 21 | 46 |
| 4 | 1.0 | 8 | 8 | 8 | 8 | 24 | 52 |
| 14 | 0.6 | 5.6 | 8 | 9.3 | 7.9 | 22 | 60 |
| 15 | 0.3 | 3.5 | 8 | 11.7 | 7.9 | 22 | >80 |
| 16 | 0.2 | 2.8 | 8 | 14 | 8.3 | 24 | >80 |
| 17 | 0.6 | 8 | 3 | 13.3 | 11.3 | 25 | 34 |
| 18 | 0.6 | 8 | 4 | 13.3 | 11.3 | 28 | 48 |
| 19 | 0.8 | 8 | 6 | 10 | 9.3 | 26 | 60 |
| 5 | 0.8 | 8 | 8 | 10 | 9.3 | 28 | 76 |
| 20 | 1.0 | 8 | 16 | 8 | 8 | 25 | >80 |

* D represents the diameter of the opening of the filter, L the length of the filter, and R the diameter of the filter, each in mm.

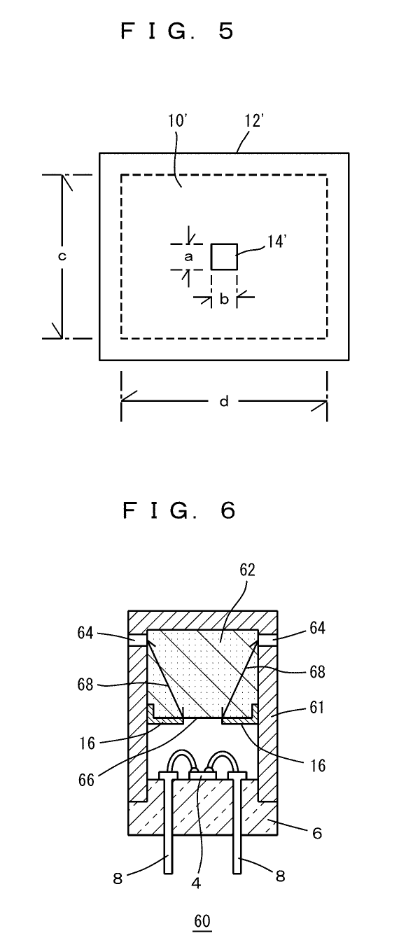

FIG. 5 shows an example where the opening 14 is not circular. The inside of cap 12′ was a rectangular tube, the length of the shorter edge is denoted by c, and the length of the longer edge by d. In a cross-section perpendicular to a direction from the opening 14′ of the filter 10′ to the unshown gas sensing element, the area of the filter 10′ is given by cd and the area of the opening 14′ by ab. A virtual diameter D′ of the opening 14′ and the total area S of the opening 14′ are related in such a way that S=π/4·D′² D′=(4S/π)^{1/2} and D′ is used. Similarly, a virtual diameter of the filter 10′ and the area S′ of the filter in the cross section are related in such a way that

S′=p/·4R′² R′=(4S′/p)^{1/2} and the virtual diameter R′ is used. The filter 10′ is set as a layer, and the thickness of the layer is used as the filter length L.

The inventor has noticed the total area S of the opening for the cases where the opening is not circular or plural openings are present and has confirmed experimentally that (4·S/p)^{1/2} is usable in place of the diameter D of the opening. This indicates the opening area is important and the shape of circular opening nor the number of the openings is not important. Therefore, L/D is replaceable by L/(4S/π)^{1/2} and L/D^{2/3} is replaceable by L/(4S/π)^{1/3}. Therefore, L/(4S/π)^{1/2} should be 5 or more and L/(4S/π)^{1/3} should be 10 or smaller. Preferably, L/(4S/π)^{1/2} is 7 or more. No transformation to the length L of the filter is necessary even when the diameter is not circular, and the lower limit of the diameter D of the opening should be determined according to the processability of D. Therefore, D is set not smaller than 0.1 mm and not larger than 1.5 mm, and L is not smaller than 3 mm and not larger than 10 mm. Preferably, D is set not smaller than 0.3 mm and not larger than 1.2 mm, L not smaller than 3 mm and not larger than 10 mm

In the embodiments, metal oxide semiconductor gas sensors have been described, but the invention is applicable to electrochemical gas sensors and contact combustion-type gas sensors. Further, the invention is similarly applicable to metal oxide semiconductor gas sensors without the mems chip 4.

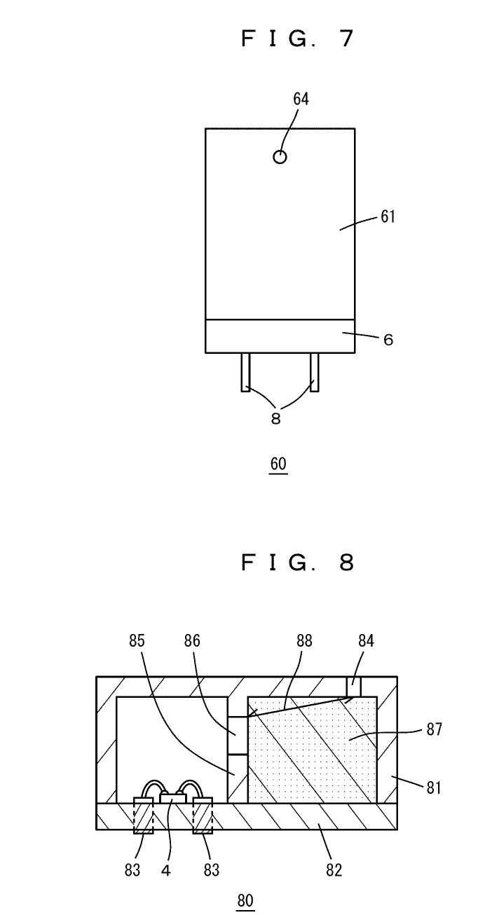

FIGS. 6 and 7 indicate a gas sensor 60 according to a second modification. A circular tube cap 61 has one or plural openings 64 on the upper side portion of it, a filter 62 comprising the silica-based adsorbent is fixed in the upper inner volume of the cap 61, and through a large opening at the bottom of the filter, the surrounding gas is supplied to the chip 4. In the case, the area of the opening is defined as the total area of the individual openings 64. Further, the length of the shortest segment 68 from the center of opening 64 at the entrance to the filter 62 to the opening 66 is defined as the length of the filter 62 from the openings 64 to the gas sensitive element (chip 4).

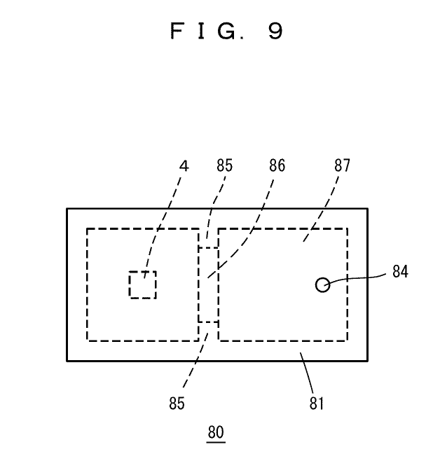

FIGS. 8 and 9 indicate a gas sensor 80 according to a third modification. The gas sensitive element (chip 4) is fixed on a base 82, and the base 82 is partly metalized and electrically connected to metal parts 83 on the bottom of the base. A cap 81 covers the base 82, and the sensor 80 is a rectangular. The cap 81 is divided into a portion including a filter 87 and a portion including the chip 4 by a partition 85. The portion including the filter 87 has one or plural openings 84, and the partition 85 has a large opening 86 to supply surrounding gas to the chip 4 side. When there are plural openings 84, the area of the opening is defined as the total area of individual openings 84. Further, the length of the shortest segment 88 from the center of opening 84 at the entrance to the filter 87 to the opening 86 is defined as the length of the filter 87 from the openings 84 to the gas sensitive element.

### DESCRIPTION OF SYMBOLS

2 gas sensor
4 chip (gas sensing element)
6 base
8 lead
10 filter
12 cap
14 opening
16 ring
17 opening
20 insulating film
22 gas sensing membrane
24 beam
26 cavity
28 pad
60,80 gas sensor
64,84 opening
68,88 line segment indicating the filter length

1. A gas sensor introducing surrounding atmosphere through a filter to a gas sensing element,
wherein the filter comprises a silica-based adsorbent containing sulfo group,
wherein the gas sensor is provided with a housing accommodating the filter and the gas sensing element,
wherein the housing is provided with an opening through which the surrounding atmosphere is introduced into the filter, and
wherein the diameter of the opening is denoted by D in mm, the length of the filter in the direction from the opening toward the gas sensing element is denoted by L in mm, and
0.1≤D≤1.5, 2≤L≤12, L/D^{2/3}≤10, and 5≤L/D.

2. The gas sensor according to claim 1, being characterized by 0.3≤D≤1.2, 3≤L≤10, and 7≤L/D.

3. The gas sensor according to claim 1, being characterized in that the diameter of the filter on a plane perpendicular to the direction from the opening toward the gas sensing element is denoted by R in mm and 6≤R≤16.

4. A gas sensor introducing surrounding atmosphere through a filter to a gas sensing element,
wherein the filter comprises a silica-based adsorbent containing sulfo group,
wherein the gas sensor is provided with a housing accommodating the filter and the gas sensing element,
wherein the housing is provided with an opening through which the surrounding atmosphere is introduced into the filter, and
wherein the diameter of the opening is denoted by D in mm, the length of the filter in the direction from the opening toward the gas sensing element is denoted by L in mm, and the area of the opening is denoted by S in mm², and
wherein 0.1≤D≤1.5, 2≤L≤12, 5≤L/(4S/π)^{1/2}, L/(4S/π)^{1/3}≤10.

5. The gas sensor according to claim 4, being characterized by 0.3≤D≤1.2, 3≤L≤10, and 7≤L/(4S/π)^{1/2}.

6. The gas sensor according to claim 4, being characterized in that an area of the filter in a sectional plane perpendicular to the direction from the opening toward the gas sensing element is denoted by S′ in mm² and 6≤L/(4S′/π)^{1/2}≤16.
